(19) United States
(12) Patent Application Publication
(10) Pub. No.: US 2015/0380231 A1
(43) Pub. Date: Dec. 31, 2015

(54) Improved Efficiency and Precise Control of Gas Phase Reactions in Mass Spectrometers Using an Auto Ejection Ion Trap

(71) Applicant: MICROMASS UK LIMITED, Wilmslow (GB)

(72) Inventors: Jeffery Mark Brown, Hyde, Cheshire (GB); Martin Raymond Green, Bowdon, Cheshire (GB); Steven Derek Pringle, Hoddlesden, Darwen (GB); Jason Lee Wildgoose, Stockport (GB)

(21) Appl. No.: 14/768,376

(22) PCT Filed: Feb. 18, 2014
(86) PCT No.: PCT/GB2014/050467

§ 371 Date: Aug. 17, 2015

(30) Foreign Application Priority Data
Feb. 18, 2013 (EP) 13155630.0
Feb. 18, 2013 (GB) 1302783.4

(51) Int. Cl. H01J 49/42; H01J 49/00

(52) U.S. Cl. CPC H01J 49/42; H01J 49/005; H01J 49/0072; H01J 49/0054; H01J 49/0027

(57) ABSTRACT

A collision or reaction device for a mass spectrometer is disclosed comprising a first device arranged and adapted to cause first ions to collide or react with charged particles and/or neutral particles or otherwise dissociate so as to form second ions. The collision or reaction device further comprises a second device arranged and adapted to apply a broadband excitation with one or more frequency notches to the first device so as to cause the second ions and/or ions derived from the second ions to be substantially ejected from the first device without causing the first ions to be substantially ejected from the first device.

### CROSS-REFERENCE TO RELATED APPLICATION

This application claims priority from and the benefit of United Kingdom patent application No. 1302783.4 filed on 18 Feb. 2013 and European patent application No. 13155630.0 filed 18 Feb. 2013. The entire contents of these applications are incorporated herein by reference.

### BACKGROUND TO THE PRESENT INVENTION

The present invention relates to a collision or reaction device for a mass spectrometer, a mass spectrometer, a method of colliding or reacting ions and a method of mass spectrometry. The preferred embodiments relates to a gas phase reaction device that facilitates the removal of the gas phase reaction ionic products in a controlled manner. The gas phase reaction device may comprise an ion-ion, ion-electron, ion-molecule or ion-metastable reaction device.

GB-2467466 (Micromass) discloses a high transmission RF ion guide with no physical axial obstructions wherein an applied electrical field may be switched between two modes of operation. In a first mode of operation the device onwardly transmits a mass range of ions and in a second mode of operation the device acts as a linear ion trap in which ions may be mass selectively displaced in at least one radial direction and subsequently ejected adiabatically in the axial direction past one or more radially dependent axial DC barriers.

It is known that mass selective radial displacement may be achieved by arranging the frequency of a supplementary time varying field to be close to a mass dependent characteristic frequency of oscillation of a group of ions within the ion guide.

The characteristic frequency is the secular frequency of ions within the ion guide. The secular frequency of an ion within the device is a function of the mass to charge ratio of the ion and is approximated by the following equation (reference is made to P. H. Dawson, Quadrupole Mass Spectrometry and Its Applications) for an RF only quadrupole:

$$ω ( m / z ) \approx \frac{\sqrt{2} \cdot z \cdot e \cdot V}{m \cdot {R}_{0}^{2} \cdot Ω} \qquad ( 1 )$$

wherein m/z is the mass to charge ratio of the ion, e is the electronic charge, V is the peak RF voltage, R₀ is the inscribed radius of the rod set and co is the angular frequency of the RF voltage.

It is known to provide a broadband excitation to a quadrupole ion guide with frequency components missing around the secular frequency of an ion. The frequency components which are missing are commonly referred to as notches. Multiple ions may be isolated in the ion guide by applying additional notches or missing frequencies.

U.S. Pat. No. 7,355,169 (McLuckey) discloses a method of peak parking. This method is based around allowing all reactant products to remain in an ion trap and only ejecting a known product ion and is specific to ion-ion reactions.

U.S. Pat. No. 5,256,875 (Hoekman) discloses a method of generating an optimised broadband filtered noise signal which may be applied to an ion trap. The broadband signal is filtered by a notch filter to generate a broadband signal whose frequency-amplitude has one or more notches. An arrangement is disclosed which enables rapid generation of different filtered noise signals.

FIG. 2 of WO 2012/051391 (Xia) relates to an arrangement wherein a broadband notched signal is applied to a linear ion trap having multiple frequency notches so as to isolate parent ions m₁. The parent ions m₁ are then fragmented by applying a discrete frequency component to form resultant fragment ions m₂. The resulting fragment ions m₂ are retained within the ion trap by virtue of the broadband notched signal having a frequency notch corresponding to m₂.

FIG. 11(b) of WO 00/33350 (Douglas) relates to an arrangement wherein a broadband notched waveform is applied in order to isolate triply charged parent ions having a mass to charge ratio of 587. The parent ions are fragmented to produce fragment ions as shown in FIG. 11(c). The dominant fragment ions having a mass to charge ratio of 726 are then isolated as shown in FIG. 11(d). First generation fragment ions having a mass to charge of 726 are then fragmented to form second generation fragment ions as shown in FIG. 11(e).

GB-2455692 (Makarov) discloses a method of operating a multi-reflection ion trap.

US 2009/0090860 (Furuhashi) discloses an ion trap mass spectrometer for MSn analysis.

GB-2421842 (Micromass) discloses a mass spectrometer with resonant ejection of unwanted ions.

GB-2452350 (Micromass) discloses a mass filter using a sequence of notched broadband frequency signals.

US 2010/0276583 (Senko) discloses a multi-resolution mass spectrometer system and intra-scanning method.

It is desired to provide an improved collision or reaction device for a mass spectrometer and an improved method of colliding or reacting ions.

### SUMMARY OF THE PRESENT INVENTION

According to an aspect of the present invention there is provided a collision or reaction device for a mass spectrometer comprising:

a first device arranged and adapted to cause first ions to collide or react with charged particles and/or neutral particles or otherwise dissociate so as to form second ions; and

a second device arranged and adapted to apply a broadband excitation with one or more frequency notches to the first device so as to cause the second ions and/or ions derived from the second ions to be substantially ejected from the first device without causing the first ions to be substantially ejected from the first device.

An important aspect of the present invention is that newly generated product ions are ejected from the device soon after they are formed whereas unfragmented or unreacted parent ions are not substantially ejected from the device.

U.S. Pat. No. 5,256,875 (Hoekman) does not teach or suggest providing a broadband frequency having frequency notches which causes fragment ions to be ejected from the device but not unfragmented or unreacted parent ions.

WO 2012/051391 (Xia) does not teach or suggest providing a broadband frequency having frequency notches which causes fragment ions to be ejected from the device but not unfragmented or unreacted parent ions. On the contrary, the teaching of WO 2012/051391 (Xia) is to provide a frequency notch m₂ so as to retain rather than eject fragment ions.

WO 00/33350 (Douglas) does not teach or suggest providing a broadband frequency having frequency notches which causes fragment ions to be ejected from the device but not unfragmented or unreacted parent ions. On the contrary, the teaching of WO 00/33350 (Douglas) is to retain fragment ions of interest and to eject any unfragmented or unreacted parent ions.

Neither GB-2421842 (Micromass) nor GB-2452350 (Micromass) teach or suggest providing a broadband frequency having frequency notches which causes fragment ions to be ejected from the device but not unfragmented or unreacted parent ions.

The present invention is particularly advantageous in that the collision or reaction device according to the present invention ensures that product or fragment ions are effectively removed from the collision or reaction region as soon as they are formed thereby preventing the product or fragment ions from undergoing further undesired reactions or from being neutralised.

According to a preferred embodiment reaction product ions are preferably removed or otherwise ejected from a collision or reaction device as soon as a reaction takes place thereby preventing the reaction product ions from undergoing further reactions which might, for example, neutralise the product ions.

The removed reaction product ions may be transferred to an analyser for subsequent analysis or further reaction. The analyser may, for example, comprise a mass spectrometer or an ion mobility separator or spectrometer. The reaction product ions may be subjected to fragmentation in, for example, an Electron Transfer Dissociation (“ETD”) or Collision Induced Dissociation (“CID”) cell.

According to an embodiment the reaction device may comprise a linear or 2D ion trap or alternatively a 3D ion trap. The reaction product ions are preferably transferred out of the ion trap either radially or axially into another analytical separation device.

According to a preferred embodiment the preferred device comprises a quadrupole rod set with a radial dependent barrier. A broadband excitation containing missing frequencies or notches is preferably applied to the electrodes in order to radially excite a plurality of ions. The ions are not lost to the rods but are axially ejected and are onwardly transported to e.g. a downstream mass analyser.

According to a preferred embodiment reacting species are preferably stored in a reaction device for a period of time in order for ion-ion, ion-electron, ion-molecule and ion-metastable reactions to occur. The reaction rate constants can be highly variable and may be different for different species reacting with the same reagent. This can result in reactions continuing on the product ions which is likely to result in poor fragmentation spectra. Conversely, if too short a period of time is allowed for the reactions to proceed then little or no fragmentation of the parent or precursor ions will occur.

For example, in the case of an Electron Transfer Dissociation experiment it is disadvantageous to allow ion-ion reactions to continue unregulated as the singly charged product ions can quickly become neutralised resulting in the product ions going undetected.

The present invention addresses the above problem by ensuring that product ions are effectively removed from the collision or reaction region as soon as they are formed. This prevents the product ions from undergoing further undesired reactions or from being neutralised.

The present invention is also particularly advantageous in that the reaction of analyte ions with reagent ions or neutral particles can be controlled in an optimal manner ensuring a high intensity of product ions is produced.

The present invention addresses a particular problem in untargeted or Data Independent Analysis (“DIA”) wherein there is little or no prior knowledge of the precursor or parent ions.

According to the preferred embodiment the charged particles comprise ions.

The collision or reaction device preferably comprises an ion-ion collision or reaction device.

The first ions are preferably caused to interact with reagent ions via Electron Transfer Dissociation (“ETD”) so as to form the second ions.

According to a less preferred embodiment the charged particles comprise electrons. The collision or reaction device preferably comprises an ion-electron collision or reaction device.

According to a less preferred embodiment the collision or reaction device comprises an ion-molecule collision or reaction device.

The first ions may be caused to interact with gas molecules and fragment via Collision Induced Dissociation (“CID”) to form the second ions.

The first ions may be caused to interact with deuterium via Hydrogen-Deuterium exchange (“HDx”) to form the second ions.

The collision or reaction device may comprise an ion-metastable collision or reaction device.

The collision or reaction device preferably comprises a gas phase collision or reaction device.

The collision or reaction device preferably comprises a linear or 2D ion trap.

The collision or reaction device preferably comprises a quadrupole rod set ion guide or ion trap.

The collision or reaction device preferably comprises a 3D ion trap.

The collision or reaction device preferably further comprises a device for applying a radially dependent trapping potential across at least a portion of the first device.

The collision or reaction device preferably further comprises a device arranged and adapted to maintain an axial DC voltage gradient and/or to apply one or more transient DC voltages to the first device in order to urge ions in a direction within the first device.

According to an aspect of the present invention there is provided a mass spectrometer comprising a collision or reaction device as described above.

According to an aspect of the present invention there is provided a method of colliding or reacting ions comprising:

providing a first device and causing first ions to collide or react with charged particles and/or neutral particles or otherwise dissociate so as to form second ions; and

applying a broadband excitation with one or more frequency notches to the first device so as to cause the second ions and/or ions derived from the second ions to be substantially ejected from the first device without causing the first ions to be substantially ejected from the first device.

According to an aspect to the present invention there is provided a method of mass spectrometry comprising a method of colliding or reacting ions as described above.

The collision or reaction device is preferably arranged and adapted to cause parent ions to fragment or react to form fragment or product ions and to cause the fragment or product ions to be auto-ejected from the device immediately the fragment or product ions are formed without auto-ejecting the parent ions.

According to another aspect of the present invention there is provided a method of colliding or reacting ions comprising:

causing parent ions to fragment or react to form fragment or product ions; and

causing the fragment or product ions to be auto-ejected from the device immediately the fragment or product ions are formed without auto-ejecting the parent ions.

The collision or reaction device or ion trap preferably comprises:

a first electrode set comprising a first plurality of electrodes;

a second electrode set comprising a second plurality of electrodes;

a third device arranged and adapted to apply one or more DC voltages to one or more of the first plurality of electrodes and/or to one or more of the second plurality electrodes so that:

(a) ions having a radial displacement within a first range experience a DC trapping field, a DC potential barrier or a barrier field which acts to confine at least some of the ions in at least one axial direction within the ion trap or collision or reaction device; and

(b) ions having a radial displacement within a second different range experience either: (i) a substantially zero DC trapping field, no DC potential barrier or no barrier field so that at least some of the ions are not confined in the at least one axial direction within the ion trap or collision or reaction device; and/or (ii) a DC extraction field, an accelerating DC potential difference or an extraction field which acts to extract or accelerate at least some of the ions in the at least one axial direction and/or out of the ion trap or collision or reaction device; and

a fourth device arranged and adapted to vary, increase, decrease or alter the radial displacement of at least some ions within the ion trap or collision or reaction device.

The fourth device may be arranged:

(i) to cause at least some ions having a radial displacement which falls within the first range at a first time to have a radial displacement which falls within the second range at a second subsequent time; and/or

(ii) to cause at least some ions having a radial displacement which falls within the second range at a first time to have a radial displacement which falls within the first range at a second subsequent time.

According to a less preferred embodiment either: (i) the first electrode set and the second electrode set comprise electrically isolated sections of the same set of electrodes and/or wherein the first electrode set and the second electrode set are formed mechanically from the same set of electrodes; and/or (ii) the first electrode set comprises a region of a set of electrodes having a dielectric coating and the second electrode set comprises a different region of the same set of electrodes; and/or (iii) the second electrode set comprises a region of a set of electrodes having a dielectric coating and the first electrode set comprises a different region of the same set of electrodes.

The second electrode set is preferably arranged downstream of the first electrode set. The axial separation between a downstream end of the first electrode set and an upstream end of the second electrode set is preferably selected from the group consisting of: (i) <1 mm; (ii) 1-2 mm; (iii) 2-3 mm; (iv) 3-4 mm; (v) 4-5 mm; (vi) 5-6 mm; (vii) 6-7 mm; (viii) 7-8 mm; (ix) 8-9 mm; (x) 9-10 mm; (xi) 10-15 mm; (xii) 15-20 mm; (xiii) 20-25 mm; (xiv) 25-30 mm; (xv) 30-35 mm; (xvi) 35-40 mm; (xvii) 40-45 mm; (xviii) 45-50 mm; and (xix) >50 mm.

The first electrode set is preferably arranged substantially adjacent to and/or coaxial with the second electrode set.

The first plurality of electrodes preferably comprises a multipole rod set, a quadrupole rod set, a hexapole rod set, an octapole rod set or a rod set having more than eight rods. The second plurality of electrodes preferably comprises a multipole rod set, a quadrupole rod set, a hexapole rod set, an octapole rod set or a rod set having more than eight rods.

According to a less preferred embodiment the first plurality of electrodes may comprise a plurality of electrodes or at least 5, 10, 15, 20, 25, 30, 35, 40, 45, 50, 55, 60, 65, 70, 75, 80, 85, 90, 95, 100, 110, 120, 130, 140, 150, 160, 170, 180, 190 or 200 electrodes having apertures through which ions are transmitted in use. According to a less preferred embodiment the second plurality of electrodes may comprise a plurality of electrodes or at least 5, 10, 15, 20, 25, 30, 35, 40, 45, 50, 55, 60, 65, 70, 75, 80, 85, 90, 95, 100, 110, 120, 130, 140, 150, 160, 170, 180, 190 or 200 electrodes having apertures through which ions are transmitted in use.

According to the preferred embodiment the first electrode set has a first axial length and the second electrode set has a second axial length, and wherein the first axial length is substantially greater than the second axial length and/or wherein the ratio of the first axial length to the second axial length is at least 2, 3, 4, 5, 6, 7, 8, 9, 10, 11, 12, 13, 14, 15, 16, 17, 18, 19, 20, 25, 30, 35, 40, 45 or 50.

The third device is preferably arranged and adapted to apply one or more DC voltages to one or more of the first plurality of electrodes and/or to one or more of the second plurality of electrodes so as to create, in use, an electric potential within the first electrode set and/or within the second electrode set which increases and/or decreases and/or varies with radial displacement in a first radial direction as measured from a central longitudinal axis of the first electrode set and/or the second electrode set. The third device is preferably arranged and adapted to apply one or more DC voltages to one or more of the first plurality of electrodes and/or to one or more of the second plurality of electrodes so as to create, in use, an electric potential which increases and/or decreases and/or varies with radial displacement in a second radial direction as measured from a central longitudinal axis of the first electrode set and/or the second electrode set. The second radial direction is preferably orthogonal to the first radial direction.

According to the preferred embodiment the third device may be arranged and adapted to apply one or more DC voltages to one or more of the first plurality of electrodes and/or to one or more of the second plurality of electrodes so as to confine at least some positive and/or negative ions axially within the ion trap or collision or reaction device if the ions have a radial displacement as measured from a central longitudinal axis of the first electrode set and/or the second electrode set greater than or less than a first value.

According to the preferred embodiment the third device is preferably arranged and adapted to create, in use, one or more radially dependent axial DC potential barriers at one or more axial positions along the length of the ion trap or collision or reaction device. The one or more radially dependent axial DC potential barriers preferably substantially prevent at least some or at least 5%, 10%, 15%, 20%, 25%, 30%, 35%, 40%, 45%, 50%, 55%, 60%, 65%, 70%, 75%, 80%, 85%, 90% or 95% of positive and/or negative ions within the ion trap or collision or reaction device from passing axially beyond the one or more axial DC potential barriers and/or from being extracted axially from the ion trap or collision or reaction device.

The third device is preferably arranged and adapted to apply one or more DC voltages to one or more of the first plurality of electrodes and/or to one or more of the second plurality of electrodes so as to create, in use, an extraction field which preferably acts to extract or accelerate at least some positive and/or negative ions out of the ion trap or collision or reaction device if the ions have a radial displacement as measured from a central longitudinal axis of the first electrode and/or the second electrode greater than or less than a first value.

The third device is preferably arranged and adapted to create, in use, one or more axial DC extraction electric fields at one or more axial positions along the length of the ion trap or collision or reaction device. The one or more axial DC extraction electric fields preferably cause at least some or at least 5%, 10%, 15%, 20%, 25%, 30%, 35%, 40%, 45%, 50%, 55%, 60%, 65%, 70%, 75%, 80%, 85%, 90% or 95% of positive and/or negative ions within the ion trap or collision or reaction device to pass axially beyond the DC trapping field, DC potential barrier or barrier field and/or to be extracted axially from the ion trap, collision or reaction device.

According to the preferred embodiment the third device is arranged and adapted to create, in use, a DC trapping field, DC potential barrier or barrier field which acts to confine at least some of the ions in the at least one axial direction, and wherein the ions preferably have a radial displacement as measured from the central longitudinal axis of the first electrode set and/or the second electrode set within a range selected from the group consisting of: (i) 0-0.5 mm; (ii) 0.5-1.0 mm; (iii) 1.0-1.5 mm; (iv) 1.5-2.0 mm; (v) 2.0-2.5 mm; (vi) 2.5-3.0 mm; (vii) 3.0-3.5 mm; (viii) 3.5-4.0 mm; (ix) 4.0-4.5 mm; (x) 4.5-5.0 mm; (xi) 5.0-5.5 mm; (xii) 5.5-6.0 mm; (xiii) 6.0-6.5 mm; (xiv) 6.5-7.0 mm; (xv) 7.0-7.5 mm; (xvi) 7.5-8.0 mm; (xvii) 8.0-8.5 mm; (xviii) 8.5-9.0 mm; (xix) 9.0-9.5 mm; (xx) 9.5-10.0 mm; and (xxi) >10.0 mm.

According to the preferred embodiment the third device is arranged and adapted to provide a substantially zero DC trapping field, no DC potential barrier or no barrier field at at least one location so that at least some of the ions are not confined in the at least one axial direction within the ion trap or collision or reaction device, and wherein the ions preferably have a radial displacement as measured from the central longitudinal axis of the first electrode set and/or the second electrode set within a range selected from the group consisting of: (i) 0-0.5 mm; (ii) 0.5-1.0 mm; (iii) 1.0-1.5 mm; (iv) 1.5-2.0 mm; (v) 2.0-2.5 mm; (vi) 2.5-3.0 mm; (vii) 3.0-3.5 mm; (viii) 3.5-4.0 mm; (ix) 4.0-4.5 mm; (x) 4.5-5.0 mm; (xi) 5.0-5.5 mm; (xii) 5.5-6.0 mm; (xiii) 6.0-6.5 mm; (xiv) 6.5-7.0 mm; (xv) 7.0-7.5 mm; (xvi) 7.5-8.0 mm; (xvii) 8.0-8.5 mm; (xviii) 8.5-9.0 mm; (xix) 9.0-9.5 mm; (xx) 9.5-10.0 mm; and (xxi) >10.0 mm.

The third device is preferably arranged and adapted to create, in use, a DC extraction field, an accelerating DC potential difference or an extraction field which acts to extract or accelerate at least some of the ions in the at least one axial direction and/or out of the ion trap or collision or reaction device, and wherein the ions preferably have a radial displacement as measured from the central longitudinal axis of the first electrode set and/or the second electrode set within a range selected from the group consisting of: (i) 0-0.5 mm; (ii) 0.5-1.0 mm; (iii) 1.0-1.5 mm; (iv) 1.5-2.0 mm; (v) 2.0-2.5 mm; (vi) 2.5-3.0 mm; (vii) 3.0-3.5 mm; (viii) 3.5-4.0 mm; (ix) 4.0-4.5 mm; (x) 4.5-5.0 mm; (xi) 5.0-5.5 mm; (xii) 5.5-6.0 mm; (xiii) 6.0-6.5 mm; (xiv) 6.5-7.0 mm; (xv) 7.0-7.5 mm; (xvi) 7.5-8.0 mm; (xvii) 8.0-8.5 mm; (xviii) 8.5-9.0 mm; (xix) 9.0-9.5 mm; (xx) 9.5-10.0 mm; and (xxi) >10.0 mm.

The first plurality of electrodes preferably have an inscribed radius of r1 and a first longitudinal axis and/or wherein the second plurality of electrodes have an inscribed radius of r2 and a second longitudinal axis.

The third device is preferably arranged and adapted to create a DC trapping field, a DC potential barrier or a barrier field which acts to confine at least some of the ions in the at least one axial direction within the ion trap or collision or reaction device and wherein the DC trapping field, DC potential barrier or barrier field increases and/or decreases and/or varies with increasing radius or displacement in a first radial direction away from the first longitudinal axis and/or the second longitudinal axis up to at least 5%, 10%, 15%, 20%, 25%, 30%, 35%, 40%, 45%, 50%, 55%, 60%, 65%, 70%, 75%, 80%, 85%, 90%, 95% or 100% of the first inscribed radius r1 and/or the second inscribed radius r2.

The third device is preferably arranged and adapted to create a DC trapping field, DC potential barrier or barrier field which acts to confine at least some of the ions in the at least one axial direction within the ion trap or collision or reaction device and wherein the DC trapping field, DC potential barrier or barrier field increases and/or decreases and/or varies with increasing radius or displacement in a second radial direction away from the first longitudinal axis and/or the second longitudinal axis up to at least 5%, 10%, 15%, 20%, 25%, 30%, 35%, 40%, 45%, 50%, 55%, 60%, 65%, 70%, 75%, 80%, 85%, 90%, 95% or 100% of the first inscribed radius r1 and/or the second inscribed radius r2. The second radial direction is preferably orthogonal to the first radial direction.

The third device is preferably arranged and adapted to provide substantially zero DC trapping field, no DC potential barrier or no barrier field at at least one location so that at least some of the ions are not confined in the at least one axial direction within the ion trap or collision or reaction device and wherein the substantially zero DC trapping field, no DC potential barrier or no barrier field extends with increasing radius or displacement in a first radial direction away from the first longitudinal axis and/or the second longitudinal axis up to at least 5%, 10%, 15%, 20%, 25%, 30%, 35%, 40%, 45%, 50%, 55%, 60%, 65%, 70%, 75%, 80%, 85%, 90%, 95% or 100% of the first inscribed radius r1 and/or the second inscribed radius r2. The third device is preferably arranged and adapted to provide a substantially zero DC trapping field, no DC potential barrier or no barrier field at at least one location so that at least some of the ions are not confined in the at least one axial direction within the ion trap or collision or reaction device and wherein the substantially zero DC trapping field, no DC potential barrier or no barrier field extends with increasing radius or displacement in a second radial direction away from the first longitudinal axis and/or the second longitudinal axis up to at least 5%, 10%, 15%, 20%, 25%, 30%, 35%, 40%, 45%, 50%, 55%, 60%, 65%, 70%, 75%, 80%, 85%, 90%, 95% or 100% of the first inscribed radius r1 and/or the second inscribed radius r2. The second radial direction is preferably orthogonal to the first radial direction.

The third device is arranged and adapted to create a DC extraction field, an accelerating DC potential difference or an extraction field which acts to extract or accelerate at least some of the ions in the at least one axial direction and/or out of the ion trap or collision or reaction device and wherein the DC extraction field, accelerating DC potential difference or extraction field increases and/or decreases and/or varies with increasing radius or displacement in a first radial direction away from the first longitudinal axis and/or the second longitudinal axis up to at least 5%, 10%, 15%, 20%, 25%, 30%, 35%, 40%, 45%, 50%, 55%, 60%, 65%, 70%, 75%, 80%, 85%, 90%, 95% or 100% of the first inscribed radius r1 and/or the second inscribed radius r2. The third device is preferably arranged and adapted to create a DC extraction field, an accelerating DC potential difference or an extraction field which acts to extract or accelerate at least some of the ions in the at least one axial direction and/or out of the ion trap or collision or reaction device and wherein the DC extraction field, accelerating DC potential difference or extraction field increases and/or decreases and/or varies with increasing radius or displacement in a second radial direction away from the first longitudinal axis and/or the second longitudinal axis up to at least 5%, 10%, 15%, 20%, 25%, 30%, 35%, 40%, 45%, 50%, 55%, 60%, 65%, 70%, 75%, 80%, 85%, 90%, 95% or 100% of the first inscribed radius r1 and/or the second inscribed radius r2. The second radial direction is preferably orthogonal to the first radial direction.

According to the preferred embodiment the DC trapping field, DC potential barrier or barrier field which acts to confine at least some of the ions in the at least one axial direction within the ion trap or collision or reaction device is created at one or more axial positions along the length of the ion trap or collision or reaction device and at least at an distance x mm upstream and/or downstream from the axial centre of the first electrode set and/or the second electrode set, wherein x is preferably selected from the group consisting of: (i) <1; (ii) 1-2; (iii) 2-3; (iv) 3-4; (v) 4-5; (vi) 5-6; (vii) 6-7; (viii) 7-8; (ix) 8-9; (x) 9-10; (xi) 10-15; (xii) 15-20; (xiii) 20-25; (xiv) 25-30; (xv) 30-35; (xvi) 35-40; (xvii) 40-45; (xviii) 45-50; and (xix) >50.

According to the preferred embodiment the zero DC trapping field, the no DC potential barrier or the no barrier field is provided at one or more axial positions along the length of the ion trap or collision or reaction device and at least at an distance y mm upstream and/or downstream from the axial centre of the first electrode set and/or the second electrode set, wherein y is preferably selected from the group consisting of: (i) <1; (ii) 1-2; (iii) 2-3; (iv) 3-4; (v) 4-5; (vi) 5-6; (vii) 6-7; (viii) 7-8; (ix) 8-9; (x) 9-10; (xi) 10-15; (xii) 15-20; (xiii) 20-25; (xiv) 25-30; (xv) 30-35; (xvi) 35-40; (xvii) 40-45; (xviii) 45-50; and (xix) >50.

According to the preferred embodiment the DC extraction field, the accelerating DC potential difference or the extraction field which acts to extract or accelerate at least some of the ions in the at least one axial direction and/or out of the ion trap or collision or reaction device is created at one or more axial positions along the length of the ion trap or collision or reaction device and at least at an distance z mm upstream and/or downstream from the axial centre of the first electrode set and/or the second electrode set, wherein z is preferably selected from the group consisting of: (i) <1; (ii) 1-2; (iii) 2-3; (iv) 3-4; (v) 4-5; (vi) 5-6; (vii) 6-7; (viii) 7-8; (ix) 8-9; (x) 9-10; (xi) 10-15; (xii) 15-20; (xiii) 20-25; (xiv) 25-30; (xv) 30-35; (xvi) 35-40; (xvii) 40-45; (xviii) 45-50; and (xix) >50.

The third device is preferably arranged and adapted to apply the one or more DC voltages to one or more of the first plurality of electrodes and/or to one or more of the second plurality of electrodes so that either:

(i) the radial and/or the axial position of the DC trapping field, DC potential barrier or barrier field remains substantially constant whilst ions are being ejected axially from the ion trap or collision or reaction device in a mode of operation; and/or

(ii) the radial and/or the axial position of the substantially zero DC trapping field, no DC potential barrier or no barrier field remains substantially constant whilst ions are being ejected axially from the ion trap or collision or reaction device in a mode of operation; and/or

(iii) the radial and/or the axial position of the DC extraction field, accelerating DC potential difference or extraction field remains substantially constant whilst ions are being ejected axially from the ion trap or collision or reaction device in a mode of operation.

The third device is preferably arranged and adapted to apply the one or more DC voltages to one or more of the first plurality of electrodes and/or to one or more of the second plurality of electrodes so as to:

(i) vary, increase, decrease or scan the radial and/or the axial position of the DC trapping field, DC potential barrier or barrier field whilst ions are being ejected axially from the ion trap or collision or reaction device in a mode of operation; and/or

(ii) vary, increase, decrease or scan the radial and/or the axial position of the substantially zero DC trapping field, no DC potential barrier or no barrier field whilst ions are being ejected axially from the ion trap or collision or reaction device in a mode of operation; and/or

(iii) vary, increase, decrease or scan the radial and/or the axial position of the DC extraction field, accelerating DC potential difference or extraction field whilst ions are being ejected axially from the ion trap or collision or reaction device in a mode of operation.

The third device is preferably arranged and adapted to apply the one or more DC voltages to one or more of the first plurality of electrodes and/or to one or more of the second plurality of electrodes so that:

(i) the amplitude of the DC trapping field, DC potential barrier or barrier field remains substantially constant whilst ions are being ejected axially from the ion trap or collision or reaction device in a mode of operation; and/or

(ii) the substantially zero DC trapping field, the no DC potential barrier or the no barrier field remains substantially zero whilst ions are being ejected axially from the ion trap or collision or reaction device in a mode of operation; and/or

(iii) the amplitude of the DC extraction field, accelerating DC potential difference or extraction field remains substantially constant whilst ions are being ejected axially from the ion trap or collision or reaction device in a mode of operation.

According to an embodiment the third device is preferably arranged and adapted to apply the one or more DC voltages to one or more of the first plurality of electrodes and/or to one or more of the second plurality of electrodes so as to:

(i) vary, increase, decrease or scan the amplitude of the DC trapping field, DC potential barrier or barrier field whilst ions are being ejected axially from the ion trap or collision or reaction device in a mode of operation; and/or

(ii) vary, increase, decrease or scan the amplitude of the DC extraction field, accelerating DC potential difference or extraction field whilst ions are being ejected axially from the ion trap or collision or reaction device in a mode of operation.

The fourth device is preferably arranged and adapted to apply a first phase and/or a second opposite phase of one or more excitation, AC or tickle voltages to at least some of the first plurality of electrodes and/or to at least some of the second plurality of electrodes in order to excite at least some ions in at least one radial direction within the first electrode set and/or within the second electrode set and so that at least some ions are subsequently urged in the at least one axial direction and/or are ejected axially from the ion trap or collision or reaction device and/or are moved past the DC trapping field, the DC potential or the barrier field. The ions which are urged in the at least one axial direction and/or are ejected axially from the ion trap or collision or reaction device and/or are moved past the DC trapping field, the DC potential or the barrier field preferably move along an ion path formed within the second electrode set.

The fourth device is preferably arranged and adapted to apply a first phase and/or a second opposite phase of one or more excitation, AC or tickle voltages to at least some of the first plurality of electrodes and/or to at least some of the second plurality of electrodes in order to excite in a mass or mass to charge ratio selective manner at least some ions radially within the first electrode set and/or the second electrode set to increase in a mass or mass to charge ratio selective manner the radial motion of at least some ions within the first electrode set and/or the second electrode set in at least one radial direction.

Preferably, the one or more excitation, AC or tickle voltages have an amplitude selected from the group consisting of: (i) <50 mV peak to peak; (ii) 50-100 mV peak to peak; (iii) 100-150 mV peak to peak; (iv) 150-200 mV peak to peak; (v) 200-250 mV peak to peak; (vi) 250-300 mV peak to peak; (vii) 300-350 mV peak to peak; (viii) 350-400 mV peak to peak; (ix) 400-450 mV peak to peak; (x) 450-500 mV peak to peak; and (xi) >500 mV peak to peak. Preferably, the one or more excitation, AC or tickle voltages have a frequency selected from the group consisting of: (i) <10 kHz; (ii) 10-20 kHz; (iii) 20-30 kHz; (iv) 30-40 kHz; (v) 40-50 kHz; (vi) 50-60 kHz; (vii) 60-70 kHz; (viii) 70-80 kHz; (ix) 80-90 kHz; (x) 90-100 kHz; (xi) 100-110 kHz; (xii) 110-120 kHz; (xiii) 120-130 kHz; (xiv) 130-140 kHz; (xv) 140-150 kHz; (xvi) 150-160 kHz; (xvii) 160-170 kHz; (xviii) 170-180 kHz; (xix) 180-190 kHz; (xx) 190-200 kHz; and (xxi) 200-250 kHz; (xxii) 250-300 kHz; (xxiii) 300-350 kHz; (xxiv) 350-400 kHz; (xxv) 400-450 kHz; (xxvi) 450-500 kHz; (xxvii) 500-600 kHz; (xxviii) 600-700 kHz; (xxix) 700-800 kHz; (xxx) 800-900 kHz; (xxxi) 900-1000 kHz; and (xxxii) >1 MHz.

According to the preferred embodiment the fourth device is arranged and adapted to maintain the frequency and/or amplitude and/or phase of the one or more excitation, AC or tickle voltages applied to at least some of the first plurality of electrodes and/or at least some of the second plurality of electrodes substantially constant.

According to the preferred embodiment the fourth device is arranged and adapted to vary, increase, decrease or scan the frequency and/or amplitude and/or phase of the one or more excitation, AC or tickle voltages applied to at least some of the first plurality of electrodes and/or at least some of the second plurality of electrodes.

The first electrode set preferably comprises a first central longitudinal axis and wherein:

(i) there is a direct line of sight along the first central longitudinal axis; and/or

(ii) there is substantially no physical axial obstruction along the first central longitudinal axis; and/or

(iii) ions transmitted, in use, along the first central longitudinal axis are transmitted with an ion transmission efficiency of substantially 100%.

The second electrode set preferably comprises a second central longitudinal axis and wherein:

(i) there is a direct line of sight along the second central longitudinal axis; and/or

(ii) there is substantially no physical axial obstruction along the second central longitudinal axis; and/or

(iii) ions transmitted, in use, along the second central longitudinal axis are transmitted with an ion transmission efficiency of substantially 100%.

According to the preferred embodiment the first plurality of electrodes have individually and/or in combination a first cross-sectional area and/or shape and wherein the second plurality of electrodes have individually and/or in combination a second cross-sectional area and/or shape, wherein the first cross-sectional area and/or shape is substantially the same as the second cross-sectional area and/or shape at one or more points along the axial length of the first electrode set and the second electrode set and/or wherein the first cross-sectional area and/or shape at the downstream end of the first plurality of electrodes is substantially the same as the second cross-sectional area and/or shape at the upstream end of the second plurality of electrodes.

According to a less preferred embodiment the first plurality of electrodes have individually and/or in combination a first cross-sectional area and/or shape and wherein the second plurality of electrodes have individually and/or in combination a second cross-sectional area and/or shape, wherein the ratio of the first cross-sectional area and/or shape to the second cross-sectional area and/or shape at one or more points along the axial length of the first electrode set and the second electrode set and/or at the downstream end of the first plurality of electrodes and at the upstream end of the second plurality of electrodes is selected from the group consisting of: (i) <0.50; (ii) 0.50-0.60; (iii) 0.60-0.70; (iv) 0.70-0.80; (v) 0.80-0.90; (vi) 0.90-1.00; (vii) 1.00-1.10; (viii) 1.10-1.20; (ix) 1.20-1.30; (x) 1.30-1.40; (xi) 1.40-1.50; and (xii) >1.50.

According to the preferred embodiment the ion trap or collision or reaction device preferably further comprises a first plurality of vane or secondary electrodes arranged between the first electrode set and/or a second plurality of vane or secondary electrodes arranged between the second electrode set.

The first plurality of vane or secondary electrodes and/or the second plurality of vane or secondary electrodes preferably each comprise a first group of vane or secondary electrodes arranged in a first plane and/or a second group of electrodes arranged in a second plane. The second plane is preferably orthogonal to the first plane.

The first groups of vane or secondary electrodes preferably comprise a first set of vane or secondary electrodes arranged on one side of the first longitudinal axis of the first electrode set and/or the second longitudinal axis of the second electrode set and a second set of vane or secondary electrodes arranged on an opposite side of the first longitudinal axis and/or the second longitudinal axis. The first set of vane or secondary electrodes and/or the second set of vane or secondary electrodes preferably comprises at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 vane or secondary electrodes.

The second groups of vane or secondary electrodes preferably comprise a third set of vane or secondary electrodes arranged on one side of the first longitudinal axis and/or the second longitudinal axis and a fourth set of vane or secondary electrodes arranged on an opposite side of the first longitudinal axis and/or the second longitudinal axis. The third set of vane or secondary electrodes and/or the fourth set of vane or secondary electrodes preferably comprises at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95 or 100 vane or secondary electrodes.

Preferably, the first set of vane or secondary electrodes and/or the second set of vane or secondary electrodes and/or the third set of vane or secondary electrodes and/or the fourth set of vane or secondary electrodes are arranged between different pairs of electrodes forming the first electrode set and/or the second electrode set.

The ion trap or collision or reaction device preferably further comprises a sixth device arranged and adapted to apply one or more first DC voltages and/or one or more second DC voltages either: (i) to at least some of the vane or secondary electrodes; and/or (ii) to the first set of vane or secondary electrodes; and/or (iii) to the second set of vane or secondary electrodes; and/or (iv) to the third set of vane or secondary electrodes; and/or (v) to the fourth set of vane or secondary electrodes.

The one or more first DC voltages and/or the one or more second DC voltages preferably comprise one or more transient DC voltages or potentials and/or one or more transient DC voltage or potential waveforms.

The one or more first DC voltages and/or the one or more second DC voltages preferably cause:

(i) ions to be urged, driven, accelerated or propelled in an axial direction and/or towards an entrance or first region of the ion trap or collision or reaction device along at least a part of the axial length of the ion trap or collision or reaction device; and/or

(ii) ions, which have been excited in at least one radial direction, to be urged, driven, accelerated or propelled in an opposite axial direction and/or towards an exit or second region of the ion trap or collision or reaction device along at least a part of the axial length of the ion trap or collision or reaction device.

The one or more first DC voltages and/or the one or more second DC voltages preferably have substantially the same amplitude or different amplitudes. The amplitude of the one or more first DC voltages and/or the one or more second DC voltages are preferably selected from the group consisting of: (i) <1 V; (ii) 1-2 V; (iii) 2-3 V; (iv) 3-4 V; (v) 4-5 V; (vi) 5-6 V; (vii) 6-7 V; (viii) 7-8 V; (ix) 8-9 V; (x) 9-10 V; (xi) 10-15 V; (xii) 15-20 V; (xiii) 20-25 V; (xiv) 25-30 V; (xv) 30-35 V; (xvi) 35-40 V; (xvii) 40-45 V; (xviii) 45-50 V; and (xix) >50 V.

The fourth device is preferably arranged and adapted to apply a first phase and/or a second opposite phase of one or more excitation, AC or tickle voltages either: (i) to at least some of the vane or secondary electrodes; and/or (ii) to the first set of vane or secondary electrodes; and/or (iii) to the second set of vane or secondary electrodes; and/or (iv) to the third set of vane or secondary electrodes; and/or (v) to the fourth set of vane or secondary electrodes; in order to excite at least some ions in at least one radial direction within the first electrode set and/or the second electrode set and so that at least some ions are subsequently urged in the at least one axial direction and/or ejected axially from the ion trap or collision or reaction device and/or moved past the DC trapping field, the DC potential or the barrier field.

The ions which are urged in the at least one axial direction and/or are ejected axially from the ion trap or collision or reaction device and/or are moved past the DC trapping field, the DC potential or the barrier field preferably move along an ion path formed within the second electrode set.

According to the preferred embodiment the fourth device is arranged and adapted to apply a first phase and/or a second opposite phase of one or more excitation, AC or tickle voltages either: (i) to at least some of the vane or secondary electrodes; and/or (ii) to the first set of vane or secondary electrodes; and/or (iii) to the second set of vane or secondary electrodes; and/or (iv) to the third set of vane or secondary electrodes; and/or (v) to the fourth set of vane or secondary electrodes; in order to excite in a mass or mass to charge ratio selective manner at least some ions radially within the first electrode set and/or the second electrode set to increase in a mass or mass to charge ratio selective manner the radial motion of at least some ions within the first electrode set and/or the second electrode set in at least one radial direction.

Preferably, the one or more excitation, AC or tickle voltages have an amplitude selected from the group consisting of: (i) <50 mV peak to peak; (ii) 50-100 mV peak to peak; (iii) 100-150 mV peak to peak; (iv) 150-200 mV peak to peak; (v) 200-250 mV peak to peak; (vi) 250-300 mV peak to peak; (vii) 300-350 mV peak to peak; (viii) 350-400 mV peak to peak; (ix) 400-450 mV peak to peak; (x) 450-500 mV peak to peak; and (xi) >500 mV peak to peak.

Preferably, the one or more excitation, AC or tickle voltages have a frequency selected from the group consisting of: (i) <10 kHz; (ii) 10-20 kHz; (iii) 20-30 kHz; (iv) 30-40 kHz; (v) 40-50 kHz; (vi) 50-60 kHz; (vii) 60-70 kHz; (viii) 70-80 kHz; (ix) 80-90 kHz; (x) 90-100 kHz; (xi) 100-110 kHz; (xii) 110-120 kHz; (xiii) 120-130 kHz; (xiv) 130-140 kHz; (xv) 140-150 kHz; (xvi) 150-160 kHz; (xvii) 160-170 kHz; (xviii) 170-180 kHz; (xix) 180-190 kHz; (xx) 190-200 kHz; and (xxi) 200-250 kHz; (xxii) 250-300 kHz; (xxiii) 300-350 kHz; (xxiv) 350-400 kHz; (xxv) 400-450 kHz; (xxvi) 450-500 kHz; (xxvii) 500-600 kHz; (xxviii) 600-700 kHz; (xxix) 700-800 kHz; (xxx) 800-900 kHz; (xxxi) 900-1000 kHz; and (xxxii) >1 MHz.

The fourth device may be arranged and adapted to maintain the frequency and/or amplitude and/or phase of the one or more excitation, AC or tickle voltages applied to at least some of the plurality of vane or secondary electrodes substantially constant.

The fourth device may be arranged and adapted to vary, increase, decrease or scan the frequency and/or amplitude and/or phase of the one or more excitation, AC or tickle voltages applied to at least some of the plurality of vane or secondary electrodes.

The first plurality of vane or secondary electrodes preferably have individually and/or in combination a first cross-sectional area and/or shape. The second plurality of vane or secondary electrodes preferably have individually and/or in combination a second cross-sectional area and/or shape. The first cross-sectional area and/or shape is preferably substantially the same as the second cross-sectional area and/or shape at one or more points along the length of the first plurality of vane or secondary electrodes and the second plurality of vane or secondary electrodes.

The first plurality of vane or secondary electrodes may have individually and/or in combination a first cross-sectional area and/or shape and wherein the second plurality of vane or secondary electrodes have individually and/or in combination a second cross-sectional area and/or shape. The ratio of the first cross-sectional area and/or shape to the second cross-sectional area and/or shape at one or more points along the length of the first plurality of vane or secondary electrodes and the second plurality of vane or secondary electrodes is selected from the group consisting of: (i) <0.50; (ii) 0.50-0.60; (iii) 0.60-0.70;

(iv) 0.70-0.80; (v) 0.80-0.90; (vi) 0.90-1.00; (vii) 1.00-1.10; (viii) 1.10-1.20; (ix) 1.20-1.30; (x) 1.30-1.40; (xi) 1.40-1.50; and (xii) >1.50.

The ion trap or collision or reaction device preferably further comprises a fifth device arranged and adapted to apply a first AC or RF voltage to the first electrode set and/or a second AC or RF voltage to the second electrode set. The first AC or RF voltage and/or the second AC or RF voltage preferably create a pseudo-potential well within the first electrode set and/or the second electrode set which acts to confine ions radially within the ion trap.

The first AC or RF voltage and/or the second AC or RF voltage preferably have an amplitude selected from the group consisting of: (i) <50 V peak to peak; (ii) 50-100 V peak to peak; (iii) 100-150 V peak to peak; (iv) 150-200 V peak to peak; (v) 200-250 V peak to peak; (vi) 250-300 V peak to peak; (vii) 300-350 V peak to peak; (viii) 350-400 V peak to peak; (ix) 400-450 V peak to peak; (x) 450-500 V peak to peak; and (xi) >500 V peak to peak.

The first AC or RF voltage and/or the second AC or RF voltage preferably have a frequency selected from the group consisting of: (i) <100 kHz; (ii) 100-200 kHz; (iii) 200-300 kHz; (iv) 300-400 kHz; (v) 400-500 kHz; (vi) 0.5-1.0 MHz; (vii) 1.0-1.5 MHz; (viii) 1.5-2.0 MHz; (ix) 2.0-2.5 MHz; (x) 2.5-3.0 MHz; (xi) 3.0-3.5 MHz; (xii) 3.5-4.0 MHz; (xiii) 4.0-4.5 MHz; (xiv) 4.5-5.0 MHz; (xv) 5.0-5.5 MHz; (xvi) 5.5-6.0 MHz; (xvii) 6.0-6.5 MHz; (xviii) 6.5-7.0 MHz; (xix) 7.0-7.5 MHz; (xx) 7.5-8.0 MHz; (xxi) 8.0-8.5 MHz; (xxii) 8.5-9.0 MHz; (xxiii) 9.0-9.5 MHz; (xxiv) 9.5-10.0 MHz; and (xxv) >10.0 MHz.

According to the preferred embodiment the first AC or RF voltage and the second AC or RF voltage have substantially the same amplitude and/or the same frequency and/or the same phase.

According to a less preferred embodiment the fifth device may be arranged and adapted to maintain the frequency and/or amplitude and/or phase of the first AC or RF voltage and/or the second AC or RF voltage substantially constant.

According to the preferred embodiment the fifth device is arranged and adapted to vary, increase, decrease or scan the frequency and/or amplitude and/or phase of the first AC or RF voltage and/or the second AC or RF voltage.

According to an embodiment the fourth device is arranged and adapted to excite ions by resonance ejection and/or mass selective instability and/or parametric excitation.

The fourth device is preferably arranged and adapted to increase the radial displacement of ions by applying one or more DC potentials to at least some of the first plurality of electrodes and/or the second plurality of electrodes.

The ion trap or collision or reaction device preferably further comprises one or more electrodes arranged upstream and/or downstream of the first electrode set and/or the second electrode set, wherein in a mode of operation one or more DC and/or AC or RF voltages are applied to the one or more electrodes in order to confine at least some ions axially within the ion trap or collision or reaction device.

In a mode of operation at least some ions are preferably arranged to be trapped or isolated in one or more upstream and/or intermediate and/or downstream regions of the ion trap or collision or reaction device.

In a mode of operation at least some ions are preferably arranged to be fragmented in one or more upstream and/or intermediate and/or downstream regions of the ion trap or collision or reaction device. The ions are preferably arranged to be fragmented by: (i) Collisional Induced Dissociation (“CID”); (ii) Surface Induced Dissociation (“SID”); (iii) Electron Transfer Dissociation; (iv) Electron Capture Dissociation; (v) Electron Collision or Impact Dissociation; (vi) Photo Induced Dissociation (“PID”); (vii) Laser Induced Dissociation; (viii) infrared radiation induced dissociation; (ix) ultraviolet radiation induced dissociation; (x) thermal or temperature dissociation; (xi) electric field induced dissociation; (xii) magnetic field induced dissociation; (xiii) enzyme digestion or enzyme degradation dissociation; (xiv) ion-ion reaction dissociation; (xv) ion-molecule reaction dissociation; (xvi) ion-atom reaction dissociation; (xvii) ion-metastable ion reaction dissociation; (xviii) ion-metastable molecule reaction dissociation; (xix) ion-metastable atom reaction dissociation; and (xx) Electron Ionisation Dissociation (“EID”).

According to an embodiment the ion trap or collision or reaction device is maintained, in a mode of operation, at a pressure selected from the group consisting of: (i) >100 mbar; (ii) >10 mbar; (iii) >1 mbar; (iv) >0.1 mbar; (v) >10⁻² mbar; (vi) >10⁻³ mbar; (vii) >10⁻⁴ mbar; (viii) >10⁻⁵ mbar; (ix) >10⁻⁶ mbar; (x) <100 mbar; (xi) <10 mbar; (xii) <1 mbar; (xiii) <0.1 mbar; (xiv)<10⁻² mbar; (xv)<10⁻³ mbar; (xvi) <10⁻⁴ mbar; (xvii) <10⁻⁵ mbar; (xviii) <10⁻⁶ mbar; (xix) 10-100 mbar; (xx) 1-10 mbar; (xxi) 0.1-1 mbar; (xxii) 10⁻² to 10⁻¹ mbar; (xxiii) 10⁻³ to 10⁻² mbar; (xxiv) 10⁻⁴ to 10⁻³ mbar; and (xxv) 10⁻⁵ to 10⁻⁴ mbar.

In a mode of operation at least some ions are preferably arranged to be separated temporally according to their ion mobility or rate of change of ion mobility with electric field strength as they pass along at least a portion of the length of the ion trap or collision or reaction device.

According to an embodiment the ion trap or collision or reaction device preferably further comprises a device or ion gate for pulsing ions into the ion trap or collision or reaction device and/or for converting a substantially continuous ion beam into a pulsed ion beam.

According to an embodiment the first electrode set and/or the second electrode set are axially segmented in a plurality of axial segments or at least 2, 3, 4, 5, 6, 7, 8, 9, 10, 11, 12, 13, 14, 15, 16, 17, 18, 19 or 20 axial segments. In a mode of operation at least some of the plurality of axial segments are preferably maintained at different DC potentials and/or wherein one or more transient DC potentials or voltages or one or more transient DC potential or voltage waveforms are applied to at least some of the plurality of axial segments so that at least some ions are trapped in one or more axial DC potential wells and/or wherein at least some ions are urged in a first axial direction and/or a second opposite axial direction.

In a mode of operation: (i) ions are ejected substantially adiabatically from the ion trap or collision or reaction device in an axial direction and/or without substantially imparting axial energy to the ions; and/or (ii) ions are ejected axially from the ion trap or collision or reaction device in an axial direction with a mean axial kinetic energy in a range selected from the group consisting of: (i) <1 eV; (ii) 1-2 eV; (iii) 2-3 eV; (iv) 3-4 eV; (v) 4-5 eV; (vi) 5-6 eV; (vii) 6-7 eV; (viii) 7-8 eV; (ix) 8-9 eV; (x) 9-10 eV; (xi) 10-15 eV; (xii) 15-20 eV; (xiii) 20-25 eV; (xiv) 25-30 eV; (xv) 30-35 eV; (xvi) 35-40 eV; and (xvii) 40-45 eV; and/or (iii) ions are ejected axially from the ion trap or collision or reaction device in an axial direction and wherein the standard deviation of the axial kinetic energy is in a range selected from the group consisting of: (i) <1 eV; (ii) 1-2 eV; (iii) 2-3 eV; (iv) 3-4 eV; (v) 4-5 eV; (vi) 5-6 eV; (vii) 6-7 eV; (viii) 7-8 eV; (ix) 8-9 eV; (x) 9-10 eV; (xi) 10-15 eV; (xii) 15-20 eV; (xiii) 20-25 eV; (xiv) 25-30 eV; (xv) 30-35 eV; (xvi) 35-40 eV; (xvii) 40-45 eV; and (xviii) 45-50 eV.

According to an embodiment in a mode of operation multiple different species of ions having different mass to charge ratios are simultaneously ejected axially from the ion trap or collision or reaction device in substantially the same and/or substantially different axial directions.

In a mode of operation an additional AC voltage may be applied to at least some of the first plurality of electrodes and/or at least some of the second plurality of electrodes. The one or more DC voltages are preferably modulated on the additional AC voltage so that at least some positive and negative ions are simultaneously confined within the ion trap or collision or reaction device and/or simultaneously ejected axially from the ion trap or collision or reaction device. Preferably, the additional AC voltage has an amplitude selected from the group consisting of: (i) <1 V peak to peak; (ii) 1-2 V peak to peak; (iii) 2-3 V peak to peak; (iv) 3-4 V peak to peak; (v) 4-5 V peak to peak; (vi) 5-6 V peak to peak; (vii) 6-7 V peak to peak; (viii) 7-8 V peak to peak; (ix) 8-9 V peak to peak; (x) 9-10 V peak to peak; and (xi) >10 V peak to peak. Preferably, the additional AC voltage has a frequency selected from the group consisting of: (i) <10 kHz; (ii) 10-20 kHz; (iii) 20-30 kHz; (iv) 30-40 kHz; (v) 40-50 kHz; (vi) 50-60 kHz; (vii) 60-70 kHz; (viii) 70-80 kHz; (ix) 80-90 kHz; (x) 90-100 kHz; (xi) 100-110 kHz; (xii) 110-120 kHz; (xiii) 120-130 kHz; (xiv) 130-140 kHz; (xv) 140-150 kHz; (xvi) 150-160 kHz; (xvii) 160-170 kHz; (xviii) 170-180 kHz; (xix) 180-190 kHz; (xx) 190-200 kHz; and (xxi) 200-250 kHz; (xxii) 250-300 kHz; (xxiii) 300-350 kHz; (xxiv) 350-400 kHz; (xxv) 400-450 kHz; (xxvi) 450-500 kHz; (xxvii) 500-600 kHz; (xxviii) 600-700 kHz; (xxix) 700-800 kHz; (xxx) 800-900 kHz; (xxxi) 900-1000 kHz; and (xxxii) >1 MHz.

The ion trap or collision or reaction device is also preferably arranged and adapted to be operated in at least one non-trapping mode of operation wherein either:

(i) DC and/or AC or RF voltages are applied to the first electrode set and/or to the second electrode set so that the ion trap or collision or reaction device operates as an RF-only ion guide or ion guide wherein ions are not confined axially within the ion guide; and/or

(ii) DC and/or AC or RF voltages are applied to the first electrode set and/or to the second electrode set so that the ion trap or collision or reaction device operates as a mass filter or mass analyser in order to mass selectively transmit some ions whilst substantially attenuating other ions.

According to a less preferred embodiment in a mode of operation ions which are not desired to be axially ejected at an instance in time may be radially excited and/or ions which are desired to be axially ejected at an instance in time are no longer radially excited or are radially excited to a lesser degree.

Ions which are desired to be axially ejected from the ion trap or collision or reaction device at an instance in time are preferably mass selectively ejected from the ion trap or collision or reaction device and/or ions which are not desired to be axially ejected from the ion trap or collision or reaction device at the instance in time are preferably not mass selectively ejected from the ion trap or collision or reaction device.

According to the preferred embodiment the first electrode set preferably comprises a first multipole rod set (e.g. a quadrupole rod set) and the second electrode set preferably comprises a second multipole rod set (e.g. a quadrupole rod set). Substantially the same amplitude and/or frequency and/or phase of an AC or RF voltage is preferably applied to the first multipole rod set and to the second multipole rod set in order to confine ions radially within the first multipole rod set and/or the second multipole rod set.

According to an aspect of the present invention there is provided an ion trap or collision or reaction device comprising:

a third device arranged and adapted to create a first DC electric field which acts to confine ions having a first radial displacement axially within the ion trap or collision or reaction device and a second DC electric field which acts to extract or axially accelerate ions having a second radial displacement from the ion trap or collision or reaction device; and

a fourth device arranged and adapted to mass selectively vary, increase, decrease or scan the radial displacement of at least some ions so that the ions are ejected axially from the ion trap or collision or reaction device whilst other ions remains confined axially within the ion trap or collision or reaction device.

According to a particularly preferred embodiment the ion trap or collision or reaction device comprises:

a first electrode set comprising a first plurality of electrodes, wherein the first plurality of electrodes preferably comprises a first quadrupole rod set;

a second electrode set comprising a second plurality of electrodes, wherein the second plurality of electrodes preferably comprises a second quadrupole rod set, wherein the second electrode set is arranged downstream of the first electrode set;

a first device arranged and adapted to apply two DC voltages to the second quadrupole rod set;

a second device arranged and adapted to vary, increase, decrease or alter the radial displacement of at least some ions within the ion trap or collision or reaction device;

wherein:

the second device is preferably arranged and adapted to apply a first phase and/or a second opposite phase of one or more excitation, AC or tickle voltages to at least some of the first plurality of electrodes in order to excite in a mass or mass to charge ratio selective manner at least some ions radially within the first electrode set so as to increase in a mass or mass to charge ratio selective manner the radial motion of at least some ions within the first electrode set in at least one radial direction; and

the first device is preferably arranged and adapted to apply the two DC voltages to the second quadrupole rod set so as to create a radially dependent axial DC potential barrier so that: (a) ions having a radial displacement within a first range experience a DC trapping field, a DC potential barrier or a barrier field which acts to confine at least some of the ions in at least one axial direction within the ion trap; and (b) ions having a radial displacement within a second different range experience a DC extraction field, an accelerating DC potential difference or an extraction field which acts to extract or accelerate at least some of the ions in the at least one axial direction and/or out of the ion trap or collision or reaction device.

According to the preferred embodiment ions are preferably ejected axially from the ion trap or collision or reaction device in an axial direction and wherein the standard deviation of the axial kinetic energy is preferably in a range selected from the group consisting of: (i) <1 eV; (ii) 1-2 eV; and (iii) 2-3 eV.

According to an embodiment the mass spectrometer may further comprise:

(a) an ion source selected from the group consisting of: (i) an Electrospray ionisation (“ESI”) ion source; (ii) an Atmospheric Pressure Photo Ionisation (“APPI”) ion source; (iii) an Atmospheric Pressure Chemical Ionisation (“APCI”) ion source; (iv) a Matrix Assisted Laser Desorption Ionisation (“MALDI”) ion source; (v) a Laser Desorption Ionisation (“LDI”) ion source; (vi) an Atmospheric Pressure Ionisation (“API”) ion source; (vii) a Desorption Ionisation on Silicon (“DIOS”) ion source; (viii) an Electron Impact (“EI”) ion source; (ix) a Chemical Ionisation (“CI”) ion source; (x) a Field Ionisation (“FI”) ion source; (xi) a Field Desorption (“FD”) ion source; (xii) an Inductively Coupled Plasma (“ICP”) ion source; (xiii) a Fast Atom Bombardment (“FAB”) ion source; (xiv) a Liquid Secondary Ion Mass Spectrometry (“LSIMS”) ion source; (xv) a Desorption Electrospray Ionisation (“DESI”) ion source; (xvi) a Nickel-63 radioactive ion source; (xvii) an Atmospheric Pressure Matrix Assisted Laser Desorption Ionisation ion source; (xviii) a Thermospray ion source; (xix) an Atmospheric Sampling Glow Discharge Ionisation (“ASGDI”) ion source; (xx) a Glow Discharge (“GD”) ion source; (xxi) an Impactor ion source; (xxii) a Direct Analysis in Real Time (“DART”) ion source; (xxiii) a Laserspray Ionisation (“LSI”) ion source; (xxiv) a Sonicspray Ionisation (“SSI”) ion source; (xxv) a Matrix Assisted Inlet Ionisation (“MAII”) ion source; and (xxvi) a Solvent Assisted Inlet Ionisation (“SAII”) ion source; and/or

(b) one or more continuous or pulsed ion sources; and/or

(c) one or more ion guides; and/or

(d) one or more ion mobility separation devices and/or one or more Field Asymmetric Ion Mobility Spectrometer devices; and/or

(e) one or more ion traps or one or more ion trapping regions; and/or

(f) one or more collision, fragmentation or reaction cells selected from the group consisting of: (i) a Collisional Induced Dissociation (“CID”) fragmentation device; (ii) a Surface Induced Dissociation (“SID”) fragmentation device; (iii) an Electron Transfer Dissociation (“ETD”) fragmentation device; (iv) an Electron Capture Dissociation (“ECD”) fragmentation device; (v) an Electron Collision or Impact Dissociation fragmentation device; (vi) a Photo Induced Dissociation (“PID”) fragmentation device; (vii) a Laser Induced Dissociation fragmentation device; (viii) an infrared radiation induced dissociation device; (ix) an ultraviolet radiation induced dissociation device; (x) a nozzle-skimmer interface fragmentation device; (xi) an in-source fragmentation device; (xii) an in-source Collision Induced Dissociation fragmentation device; (xiii) a thermal or temperature source fragmentation device; (xiv) an electric field induced fragmentation device; (xv) a magnetic field induced fragmentation device; (xvi) an enzyme digestion or enzyme degradation fragmentation device; (xvii) an ion-ion reaction fragmentation device; (xviii) an ion-molecule reaction fragmentation device; (xix) an ion-atom reaction fragmentation device; (xx) an ion-metastable ion reaction fragmentation device; (xxi) an ion-metastable molecule reaction fragmentation device; (xxii) an ion-metastable atom reaction fragmentation device; (xxiii) an ion-ion reaction device for reacting ions to form adduct or product ions; (xxiv) an ion-molecule reaction device for reacting ions to form adduct or product ions; (xxv) an ion-atom reaction device for reacting ions to form adduct or product ions; (xxvi) an ion-metastable ion reaction device for reacting ions to form adduct or product ions; (xxvii) an ion-metastable molecule reaction device for reacting ions to form adduct or product ions; (xxviii) an ion-metastable atom reaction device for reacting ions to form adduct or product ions; and (xxix) an Electron Ionisation Dissociation (“EID”) fragmentation device; and/or

(g) a mass analyser selected from the group consisting of: (i) a quadrupole mass analyser; (ii) a 2D or linear quadrupole mass analyser; (iii) a Paul or 3D quadrupole mass analyser; (iv) a Penning trap mass analyser; (v) an ion trap mass analyser; (vi) a magnetic sector mass analyser; (vii) Ion Cyclotron Resonance (“ICR”) mass analyser; (viii) a Fourier Transform Ion Cyclotron Resonance (“FTICR”) mass analyser; (ix) an electrostatic mass analyser arranged to generate an electrostatic field having a quadro-logarithmic potential distribution; (x) a Fourier Transform electrostatic mass analyser; (xi) a Fourier Transform mass analyser; (xii) a Time of Flight mass analyser; (xiii) an orthogonal acceleration Time of Flight mass analyser; and (xiv) a linear acceleration Time of Flight mass analyser; and/or

(h) one or more energy analysers or electrostatic energy analysers; and/or

(i) one or more ion detectors; and/or

(j) one or more mass filters selected from the group consisting of: (i) a quadrupole mass filter; (ii) a 2D or linear quadrupole ion trap; (iii) a Paul or 3D quadrupole ion trap; (iv) a Penning ion trap; (v) an ion trap; (vi) a magnetic sector mass filter; (vii) a Time of Flight mass filter; and (viii) a Wien filter; and/or

(k) a device or ion gate for pulsing ions; and/or

(l) a device for converting a substantially continuous ion beam into a pulsed ion beam.

The mass spectrometer may further comprise either:

(i) a C-trap and a mass analyser comprising an outer barrel-like electrode and a coaxial inner spindle-like electrode that form an electrostatic field with a quadro-logarithmic potential distribution, wherein in a first mode of operation ions are transmitted to the C-trap and are then injected into the mass analyser and wherein in a second mode of operation ions are transmitted to the C-trap and then to a collision cell or Electron Transfer Dissociation device wherein at least some ions are fragmented into fragment ions, and wherein the fragment ions are then transmitted to the C-trap before being injected into the mass analyser; and/or

(ii) a stacked ring ion guide comprising a plurality of electrodes each having an aperture through which ions are transmitted in use and wherein the spacing of the electrodes increases along the length of the ion path, and wherein the apertures in the electrodes in an upstream section of the ion guide have a first diameter and wherein the apertures in the electrodes in a downstream section of the ion guide have a second diameter which is smaller than the first diameter, and wherein opposite phases of an AC or RF voltage are applied, in use, to successive electrodes.

According to an embodiment the mass spectrometer further comprises a device arranged and adapted to supply an AC or RF voltage to the electrodes. The AC or RF voltage preferably has an amplitude selected from the group consisting of: (i) <50 V peak to peak; (ii) 50-100 V peak to peak; (iii) 100-150 V peak to peak; (iv) 150-200 V peak to peak; (v) 200-250 V peak to peak; (vi) 250-300 V peak to peak; (vii) 300-350 V peak to peak; (viii) 350-400 V peak to peak; (ix) 400-450 V peak to peak; (x) 450-500 V peak to peak; and (xi) >500 V peak to peak.

The AC or RF voltage preferably has a frequency selected from the group consisting of: (i) <100 kHz; (ii) 100-200 kHz; (iii) 200-300 kHz; (iv) 300-400 kHz; (v) 400-500 kHz; (vi) 0.5-1.0 MHz; (vii) 1.0-1.5 MHz; (viii) 1.5-2.0 MHz; (ix) 2.0-2.5 MHz; (x) 2.5-3.0 MHz; (xi) 3.0-3.5 MHz; (xii) 3.5-4.0 MHz; (xiii) 4.0-4.5 MHz; (xiv) 4.5-5.0 MHz; (xv) 5.0-5.5 MHz; (xvi) 5.5-6.0 MHz; (xvii) 6.0-6.5 MHz; (xviii) 6.5-7.0 MHz; (xix) 7.0-7.5 MHz; (xx) 7.5-8.0 MHz; (xxi) 8.0-8.5 MHz; (xxii) 8.5-9.0 MHz; (xxiii) 9.0-9.5 MHz; (xxiv) 9.5-10.0 MHz; and (xxv) >10.0 MHz.

The mass spectrometer may also comprise a chromatography or other separation device upstream of an ion source. According to an embodiment the chromatography separation device comprises a liquid chromatography or gas chromatography device. According to another embodiment the separation device may comprise: (i) a Capillary Electrophoresis (“CE”) separation device; (ii) a Capillary Electrochromatography (“CEC”) separation device; (iii) a substantially rigid ceramic-based multilayer microfluidic substrate (“ceramic tile”) separation device; or (iv) a supercritical fluid chromatography separation device.

The ion guide is preferably maintained at a pressure selected from the group consisting of: (i) <0.0001 mbar; (ii) 0.0001-0.001 mbar; (iii) 0.001-0.01 mbar; (iv) 0.01-0.1 mbar; (v) 0.1-1 mbar; (vi) 1-10 mbar; (vii) 10-100 mbar; (viii) 100-1000 mbar; and (ix)_{>}1000 mbar.

### BRIEF DESCRIPTION OF THE DRAWINGS

Various embodiments of the present invention will now be described, by way of example only, and with reference to the accompanying drawings in which:

FIG. 1 shows a collision or reaction device according to a preferred embodiment comprising a quadrupole rod set with trap electrodes which are arranged to confine ions in a radially dependent manner;

FIG. 2A shows an embodiment of the present invention wherein ion-ion reactions are performed within the quadrupole ion guide, FIG. 2B shows resulting fragment ions being radially excited within the ion guide and FIG. 2C shows the fragment ions being axially ejected from the ion guide; and

FIG. 3A shows the effect of progressively reducing the amplitude of a travelling wave applied to an axially segmented ion guide so as to progressively increase the interaction time between analyte and reagent ions and shows the total ion current as the intensity of the travelling wave is varied and also the intensity of precursor ions having a mass to charge ratio of 450 as the travelling wave amplitude is varied, FIG. 3B shows the intensity of c9 and c2 ETD fragment ions as the intensity of the travelling wave is varied, FIG. 3C shows mass spectra obtained when the intensity of the travelling wave was 0.3V wherein the ion-ion interaction time was insufficient and when the intensity of the travelling wave was 0.2V wherein the ion-ion interaction time was optimum and FIG. 3D shows a mass spectrum obtained when the intensity of the travelling wave was reduced to 0.05V resulting in an increased ion-ion interaction time which caused neutralisation of product ions.

### DETAILED DESCRIPTION OF PREFERRED EMBODIMENT

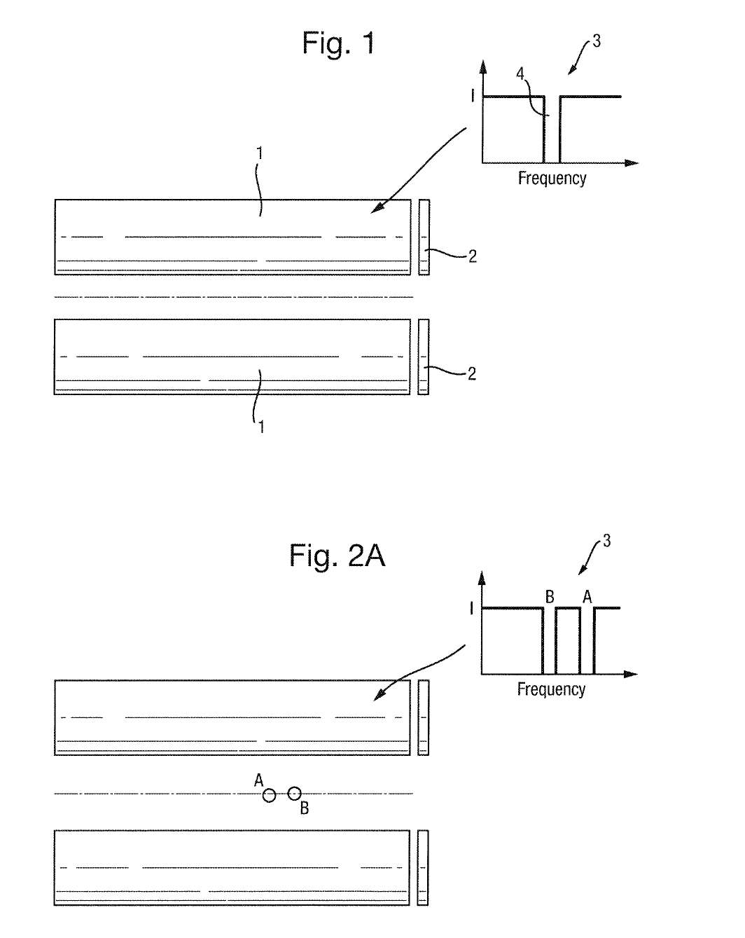

A preferred embodiment of the present invention will now be described with reference to FIG. 1.

FIG. 1 shows a quadrupole rod set comprising four quadrupole rod electrodes 1. Each of the quadrupole rod electrodes 1 is preferably provided with a radially dependent trap electrode 2. Each trap electrode 2 is preferably located at the exit region of the rod set ion guide. The trap electrodes 2 are preferably arranged to confine ions within the quadrupole rod set in a radially dependent manner. Ions along the central axis of the quadrupole rod set are preferably confined but ions having a greater radius are preferably free to pass the trap electrodes 2.

Parent or precursor ions are preferably introduced into the quadrupole ion guide and a radially dependent trapping potential is preferably applied to the exit region of the ion guide. A broadband excitation 3 is preferably applied to the main quadrupole rods 1. The broadband excitation 3 preferably has certain frequency components 4 missing in its frequency spectrum. The frequency components 4 which are missing preferably correspond with the secular frequency of the parent or precursor ions.

Ions may continually enter the preferred device from an upstream mass to charge ratio filter (not shown). Alternatively, ions may be pulsed into the quadrupole rod set ion guide.

According to an embodiment the ion guide may be arranged to contain reagent molecules so that parent ions undergo ion-molecule reactions. Alternatively, reagent ions may be introduced into the ion guide and additional frequency notches may be provided in the excitation frequencies applied to the quadrupole rod electrodes so as to enable ion-ion reactions to be performed. The additional frequency notches preferably correspond with the mass to charge ratio of the reagent ions so that the reagent ions are not ejected from the ion guide.

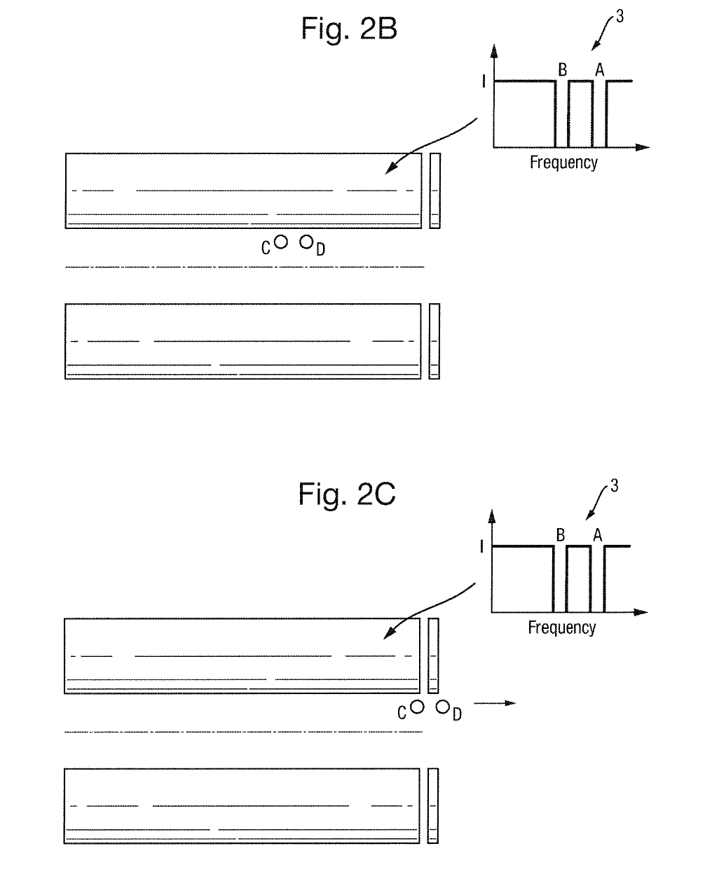

FIG. 2A shows a schematic of an embodiment wherein an ion-ion reaction such as Electron Transfer Dissociation (“ETD”) is preferably performed within the ion trap. Parent or precursor ions A are preferably introduced into the ion guide and are preferably trapped on the centre line of the quadrupole ion guide. Reagent ions B of opposite polarity are preferably introduced into the ion guide and preferably interact with the parent or precursor ions A.

Once the parent or precursor ions A have reacted with the reagent ions B then the precursor or parent ions A may fragment so as to produce fragment ions C,D as shown in FIG. 2B. According to another embodiment the precursor or parent ions may form adduct ions i.e. the precursor or parent ions do not actually fragment but their mass to charge ratio changes.

The fragment (or adduct) ions C,D are preferably radially excited as shown in FIG. 2B since the fragment ions C,D have secular frequencies which do not correspond with frequency notches in the broadband excitation frequency 3 which is preferably applied to the electrodes.

Once the fragment (or adduct) ions C,D attain a suitable radii then the fragment or adduct ions C,D are preferably efficiently removed and may be axially ejected from the ion trap as shown in FIG. 2C.

The fragment (or adduct) ions which are preferably ejected from the preferred ion guide or ion trap may be arranged to undergo further reactions or interactions.

The ion guide or ion trap may be operated in other modes of operation such as a conventional ion guide or ion trap with no detrimental effects to, for example, resolution or sensitivity.

According to an embodiment a gas phase Hydrogen-Deuterium exchange (“HDx”) experiment may be performed wherein a broadband excitation with frequency notches is applied to the ion guide. The frequency notches or missing frequencies preferably correspond to the mass to charge ratio of the analyte ions. Additional frequency notches may be included so that the exchange reaction may be forced to continue until a predetermined number of exchanges have occurred. This allows the efficient and controlled probing of exchange sites and reaction pathways and has particular applicability in, for example, biopharma quality control applications.

The exchanged ions may then be fragmented by, for example, Electron Transfer Dissociation (“ETD”) which preferably yields information on the exchange pathways and conformations that would otherwise be unavailable. A statistical study/comparison of the distributions of the exchanged sites for each integer number of exchanged sites (x=1, x=2, . . . ) is a sensitive indicator to small changes in conformation.

Alternatively, a single frequency or small band of frequencies may be applied to cause ejection of the targeted Hydrogen-Deuterium exchange (“HDx”) species.

In a similar manner ozonolyisis may be performed which is an ion-molecule reaction that produces fragmentation by way of the reaction of ozone with C═C double bonds in parent or precursor ions. The ozone reacts with the double bonds to form a primary ozonide that decomposes rapidly. This has particular use in lipidomics where isomers are often present differing only with respect to the position of the double bond by cleaving at the sites of C═C double bond(s). The identification of the lipid may accordingly be improved. Reaction rates for ozonolysis differ strongly depending upon the molecule and its conformation. Advantageously, the present invention allows the reaction time of the parent and precursor ions to be set by the reaction itself.

In an Electron Transfer Dissociation experiment it is disadvantageous to allow ion-ion reactions to continue unregulated as singly charged product ions can quickly become neutralised. According to a preferred embodiment of the present invention an Electron Transfer Dissociation experiment may be performed by applying a broadband excitation 3 with missing frequencies or notches corresponding to the mass to charge ratio of the reagent ions and the mass to charge ratio of the parent or precursor ions to the device. As soon as the parent or precursor ions fragment so as to form fragment or product ions then the resulting fragment or product ions are then preferably auto-ejected from the ion guide or ion trap. This subsequently reduces the likelihood of multiple electron transfers resulting in neutralisation occurring and is particularly advantageous.

Various further embodiments are also contemplated. In typical Electron Transfer Dissociation experiments the mass to charge ratio and charge state (n) are known. As a result, according to an embodiment frequency notches may be programmed so as to correspond to the charge reduced products at charge (n−1), (n−2) . . . etc. This embodiment is particularly advantageous in that it prevents the charge reduced products from being ejected and allows the charge reduced product ions to be available for further Electron Transfer Dissociation reactions.

The radial excitation preferably only has effect when the mass to charge ratio of ions changes. According to an embodiment additional energy may be input to the reactants at the point of binding/interaction. This energy may be exclusively provided to the ion(s)-molecules at the point of reaction. The remaining species are preferably unaffected. Such an embodiment is preferably useful in terms of controlling reaction efficiencies and/or fragmentation.

If, for example, in Electron Transfer Dissociation this energy is not beneficial to the reaction then a notch may be applied at the mass to charge ratio of the combination of precursor and reagent. In addition, the purity of the reagent ions can be maintained as any product ions formed by reactions with the reagent ions are ejected as soon as the product ions form and as such are not able to react with the analyte ions.

In another mode of operation the reaction products may be removed only when multiple or targeted reactions have taken place.

According to another embodiment the preferred device may also be utilised for Proton Transfer Reactions (“PTR”) for charge state stripping.

The invention may also be utilised to facilitate Super Charging reactions wherein the charge state of an ion is increased by protonation (or in negative ion de-protonation) as described for Electron Transfer Dissociation above.

The present invention may also be applied to more complex systems wherein, for example, analyte ions react with gas phase chromophores containing reagent and wherein two or more notches in the broadband excitation are present. Frequency notches may be provided at the mass to charge ratio of the analyte ions, the mass to charge ratio of the analyte and chromophore combination, and if the chromophore reagent is an ion then also at the mass to charge ratio of the chromophore reagent ion. The ion and chromophore combination may then be fragmented by photodissociation using radiation of a suitable wavelength.

Another example of where ion-ion reactions may benefit from the present invention is the Schiff base formation resulting from the ion-ion reaction of an aldehyde-containing reagent anion (i.e. singly deprotonated 4-formyl-1,3-benzenedisulfonic acid) with primary amine groups in multiply protonated peptide ions.

Recently, Schiff base formation in polypeptide ions has been performed along with charge inversion (Hassell K M, Stutzman J R, McLuckey S A Analytical Chemistry: 2010, 82(5):1594-1597.). For example, singly protonated peptides are reacted with doubly deprotonated 4-formyl-1,3-benzenedisulfonic acid to yield modified anions. In conjunction with Collision Induced Dissociation (“CID”) these complexes produce more informative structural information than either the singly protonated or singly deprotonated peptide.

This observation of Schiff base formation using ion-ion reactions shows the possibility for the specific covalent modification of gaseous peptide ions.

The ion-ion reaction involves initially the attachment of the reagent ion to the polypeptide ion followed by Collision Induced Dissociation induced activation. This causes water loss to takes place as the Schiff base is formed. However, water loss is a common fragmentation pathway for polypeptide ions. As a result, the population of species formed following water loss from the ion-ion complex comprises a mixture of species that includes the Schiff base product along with other species formed by dehydration.

Additionally proteins and peptides are often modified in solution to facilitate quantification, structural characterisation and sometimes ionisation. A variety of reagents have been used for selective covalent derivatization of certain amino acids in solution for example primary amine groups in peptides and proteins, such as the N-terminus or the ∈-NH2 group of a lysine residue, are commonly acetylated or modified using reactions with N-hydroxysuccinimide (NHS) derivatives. The carbonyl carbons of NHS esters undergo nucleophilic attack by primary amines resulting in loss of NHS (or sulfo-N-hydroxysuccinimide) and formation of an amide bond. Currently, these reagents have not been used in the gas phase for ion-molecule or ion-ion reactions.

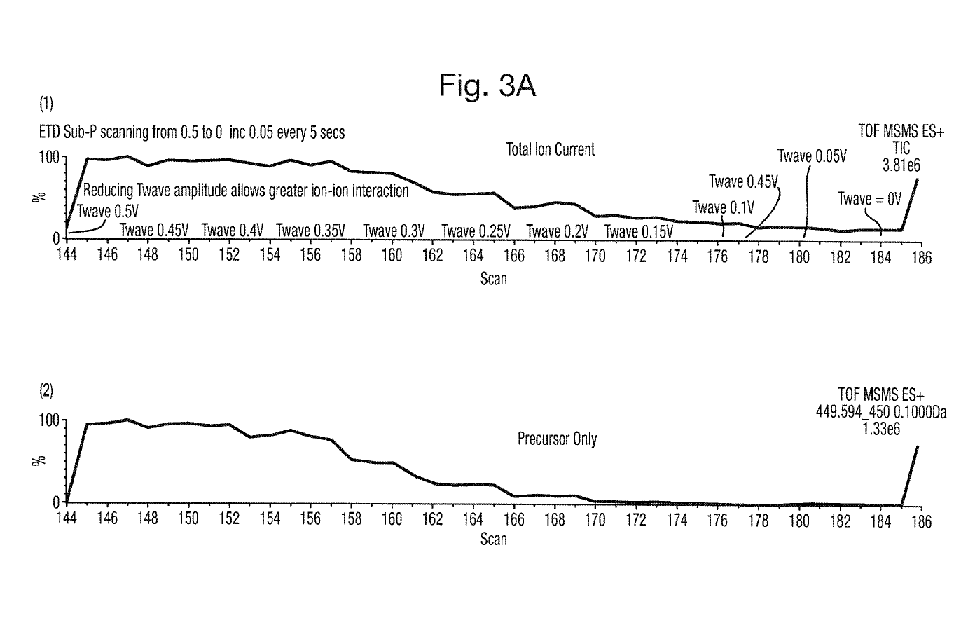

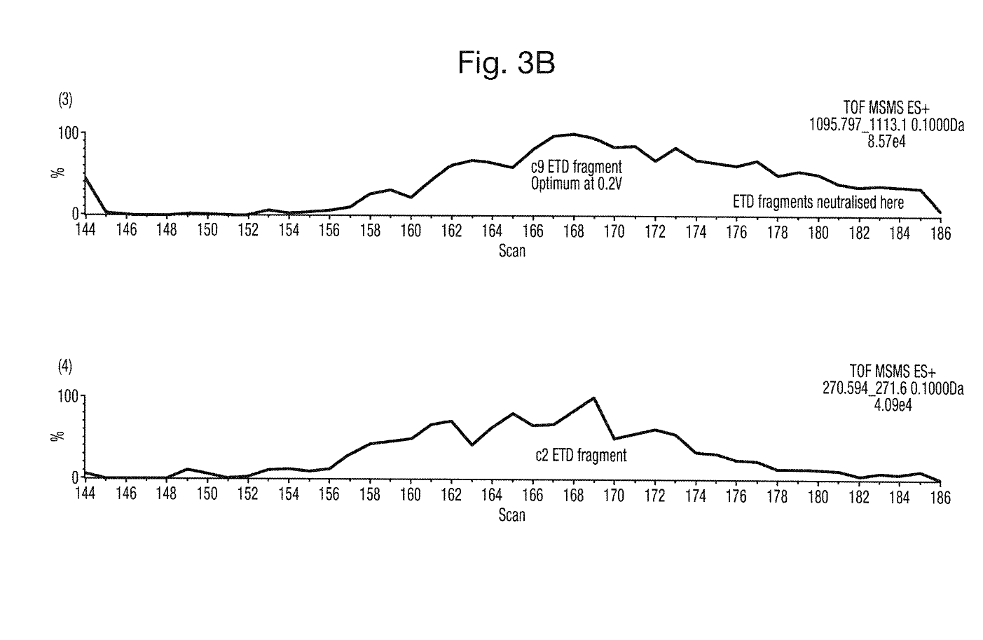

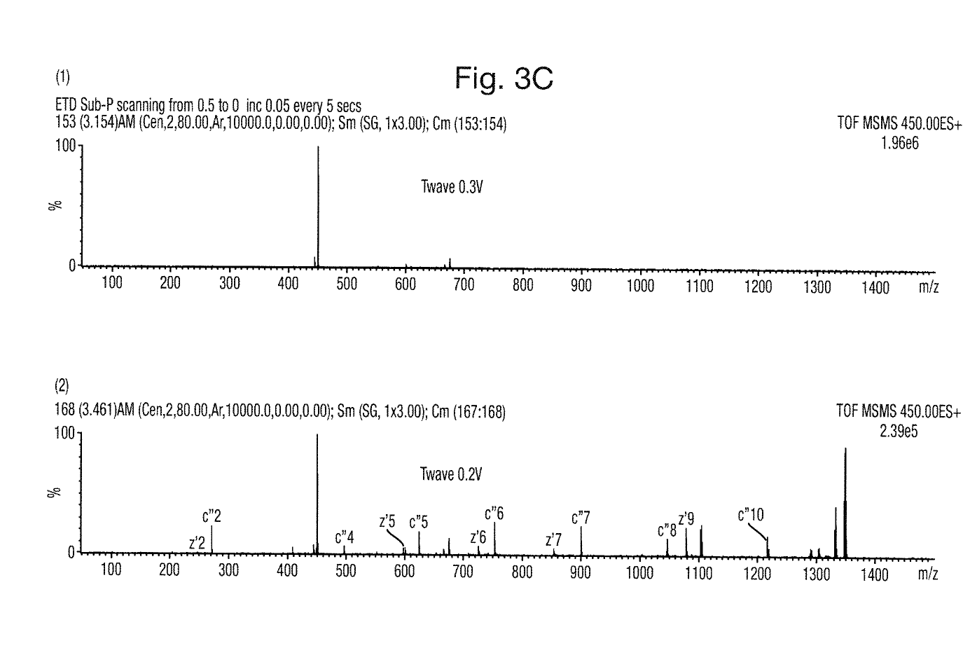

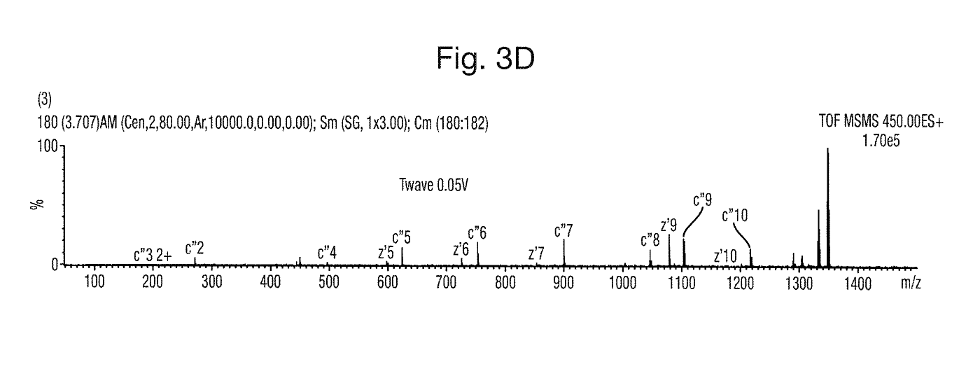

FIG. 3A-D show the results of an experiment wherein a travelling wave or T-Wave pulse height applied to an ion guide comprising a plurality of ring electrodes was ramped down from 0.5 V to 0 V which had the effect of increasing the reaction/interaction time between analyte ions and reagent ions. The analyte ions comprised triply charged ions of Substance P having a mass to charge ratio of 450 and the reagent ions comprised 1,4 dicyanobenzene.

The top plot shown in FIG. 3A shows the total ion current (“TIC”) for the experiment wherein the travelling wave amplitude was progressively reduced to increase the ion-ion interaction time. It is apparent that as the reaction time increases then the total ion current decreases indicating that the product ions which are being formed are being neutralised.

The bottom plot shown in FIG. 3A shows the intensity of triply charged ions of Substance P have a mass to charge ratio of 450 as the intensity of the travelling wave is reduced and the interaction time increases.

The top plot shown in FIG. 3B shows the intensity of c9 ETD fragment ions as the amplitude of the travelling wave is varied. Optimal fragmentation with minimal neutralisation which was obtained when the travelling wave amplitude was set at 0.2 V.

The bottom plot shown in FIG. 3B shows the intensity of c2 ETD fragment ions as the amplitude of the travelling wave is varied. When the reaction time was allowed to proceed for too long there is evidence of significant neutralisation.

The top plot shown in FIG. 3C shows a mass spectrum obtained when the travelling wave amplitude was maintained at 0.3 V with the result that the precursor ions have insufficient reaction time to fragment efficiently.

The bottom plot shown in FIG. 3C shows a mass spectrum obtained when the travelling wave amplitude was reduced to 0.2 V and shows optimal fragmentation with minimal neutralisation.

FIG. 3D shows a mass spectrum obtained when the travelling wave amplitude was further reduced to 0.05 V and corresponds with a situation wherein the reaction time was allowed to proceed for too long and there is evidence of significant neutralisation.

Although the present invention has been described with reference to preferred embodiments, it will be understood by those skilled in the art that various changes in form and detail may be made without departing from the scope of the invention as set forth in the accompanying claims.

1. A collision or reaction device for a mass spectrometer comprising:
a first device arranged and adapted to cause first ions to collide or react with charged particles or neutral particles or otherwise dissociate so as to form second ions; and
a second device arranged and adapted to apply a broadband excitation with one or more frequency notches to said first device so as to cause said second ions or ions derived from said second ions to be substantially ejected from said first device without causing said first ions to be substantially ejected from said first device.

2. A collision or reaction device as claimed in claim 1, wherein said charged particles comprise ions.

3. A collision or reaction device as claimed in claim 2, wherein said collision or reaction device comprises an ion-ion collision or reaction device.

4. A collision or reaction device as claimed in claim 3, wherein said first ions are caused to interact with reagent ions via Electron Transfer Dissociation (“ETD”) so as to form said second ions.

5. A collision or reaction device as claimed in claim 1, wherein said charged particles comprise electrons.

6. A collision or reaction device as claimed in claim 5, wherein said collision or reaction device comprises an ion-electron collision or reaction device.

7. A collision or reaction device as claimed in claim 1, wherein said collision or reaction device comprises an ion-molecule collision or reaction device.

8. A collision or reaction device as claimed in claim 7, wherein said first ions are caused to interact with gas molecules and fragment via Collision Induced Dissociation (“CID”) to form said second ions.

9. A collision or reaction device as claimed in claim 7, wherein said first ions are caused to interact with deuterium via Hydrogen-Deuterium exchange (“HDx”) to form said second ions.

10. A collision or reaction device as claimed in claim 1, wherein said collision or reaction device comprises an ion-metastable collision or reaction device.

11. A collision or reaction device as claimed in claim 1, wherein said collision or reaction device comprises a gas phase collision or reaction device.

12. A collision or reaction device as claimed in claim 1, wherein said collision or reaction device comprises a linear or 2D ion trap.

13. A collision or reaction device as claimed in claim 12, wherein said collision or reaction device comprises a quadrupole rod set ion guide or ion trap.

14. A collision or reaction device as claimed in claim 1, wherein said collision or reaction device comprises a 3D ion trap.

15. A collision or reaction device as claimed in claim 1, further comprising a device for applying a radially dependent trapping potential across at least a portion of said first device.

16. A collision or reaction device as claimed in claim 1, further comprising a device arranged and adapted to maintain an axial DC voltage gradient or to apply one or more transient DC voltages to said first device in order to urge ions in a direction within said first device.

17. A mass spectrometer comprising a collision or reaction device as claimed in claim 1.

18. A method of colliding or reacting ions comprising:
providing a first device and causing first ions to collide or react with charged particles or neutral particles or otherwise dissociate so as to form second ions; and
applying a broadband excitation with one or more frequency notches to said first device so as to cause said second ions or ions derived from said second ions to be substantially ejected from said first device without causing said first ions to be substantially ejected from said first device.

19. A method of mass spectrometry comprising a method of colliding or reacting ions as claimed in claim 18.

20. A collision or reaction device arranged and adapted to cause parent ions to fragment or react to form fragment or product ions and to cause said fragment or product ions to be auto-ejected from said device immediately said fragment or product ions are formed without auto-ejecting said parent ions.

21. A method of colliding or reacting ions with a device, said method comprising:
causing parent ions to fragment or react to form fragment or product ions; and
causing said fragment or product ions to be auto-ejected from said device immediately said fragment or product ions are formed without auto-ejecting said parent ions.
